(19) United States
(12) Patent Application Publication
(10) Pub. No.: US 2014/0172495 A1
(43) Pub. Date: Jun. 19, 2014

(54) SYSTEM AND METHOD FOR AUTOMATED BRAND PROTECTION

(71) Applicants: Phyllis Schneck, Reston, VA (US); Stephen Ritter, Solana Beach, CA (US); Sven Schrecker, San Marcos, CA (US); Ryan Nakawatase, Laguna Hills, CA (US)

(72) Inventors: Phyllis Schneck, Reston, VA (US); Stephen Ritter, Solana Beach, CA (US); Sven Schrecker, San Marcos, CA (US); Ryan Nakawatase, Laguna Hills, CA (US)

(73) Assignee: McAfee, Inc., Santa Clara, CA (US)

(21) Appl. No.: 13/716,166

(22) Filed: Dec. 16, 2012

(51) Int. Cl. G06Q 10/06

(52) U.S. Cl. CPC G06Q 10/0635
USPC 705/7.28

(57) ABSTRACT

Brand threat information is identified relating to potential threats to one or more brands of one or more organizations. A characteristic of one or more operating environments is identified and a relation is determined between a particular one of the potential threats and the characteristic. The determined relation is used to determine risk associated with a particular brand of an organization.

### TECHNICAL FIELD

This specification relates in general to risk management, and more particularly, to a system and method for automated brand protection.

### BACKGROUND

Risk is ubiquitous in all areas of life and managing risk is an activity demanding ever more time and resources, whether it is for managing a major organization or single household. In general, risk management includes identifying, assessing, and prioritizing risks, and applying resources to minimize, monitor, and control the probability and/or impact of events. Risks can originate from many uncertainties, such as uncertainty in financial markets, project failures, legal liabilities, or accidents, as well as deliberate attack from an adversary, or events of uncertain or unpredictable root-cause. Methods, definitions and goals of risk management can vary widely according to context, but strategies typically include transferring the risk to another party, avoiding the risk, reducing the negative effect or probability of the risk, or even accepting some or all of the potential or actual consequences of a particular risk.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified architecture diagram illustrating an example embodiment of a system for automated brand protection in accordance with this specification;

FIG. 2 is a simplified data flow diagram illustrating additional details that may be associated with an example embodiment of the system;

FIGS. 3A-3B are a partial listing of an example embodiment of a threat file that may be used in the system;

FIG. 4A is a simplified block diagram that illustrates additional details that may be associated with an example embodiment of a risk assessment system in an operating environment of the system;

FIG. 4B is a simplified block diagram that illustrates additional details that may be associated with an example embodiment of a brand risk intelligence system; and

FIGS. 5A-5B are simplified flow diagrams that illustrates potential operations that may be associated with example embodiments of an operating environment in the system.

### DETAILED DESCRIPTION OF EXAMPLE EMBODIMENTS

### Overview

In general, one aspect of the subject matter described in this specification can be embodied in methods that include the actions of identifying brand threat information relating to potential threats to one or more brands, identifying a characteristic of one or more operating environments, and determining a relation between a particular one of the potential threats and the characteristic. The determined relation can be used to determine risk associated with a particular brand of an organization.

In another general aspect of the subject matter described in this specification can be embodied in systems that include at least one processor device, at least one memory element, and a brand risk module. The brand risk module, when executed by the at least one processor device, can identify brand threat information relating to potential threats to one or more brands, identify a characteristic of one or more operating environments, and determine a relation between a particular one of the potential threats and the characteristic. The determined relation can be used to determine risk associated with a particular brand of an organization.

These and other embodiments can each optionally include one or more of the following features. The brand impact information can relate to a potential negative public relations impact. The brand impact information can describe an actual public relations impact on a second brand other than the particular brand and determining the relation can include identifying a relationship between the particular brand and the second brand. The particular brand can be a brand of a particular organization and the second brand can be a brand in a related industry and/or another brand of the organization. The brand impact information can include at least website data, weblog data, news data, and brand research data, among other examples. The brand impact information can identify a brand threat associated with a particular exploit of operating environments and the identified characteristic can include a particular characteristic of a particular operating environment of the organization relating to the particular exploit. Brand risk data can describe determined relations between respective operating environment characteristics and associated potential threats to one or more brands. Determining the risk can include identifying particular brand risk data pertaining to at least one condition of a particular operating environment of the organization. Determining risk can further include determining whether the particular operating environment is vulnerable to the exploit based on the particular characteristic of the particular operating environment. A brand risk score can be determined for the particular brand based at least in part on the determined relation. Further, a composite risk score can be generated for an operating environment based at least in part on the brand risk score and at least one other risk score component.

Further, these and other embodiments can also each optionally include one or more of the following features. Brand risk data can be generated that describes the determined relation and the brand risk data can be provided to a particular operating environment, where the determination of risk is at least partially performed. Brand impact information can include unstructured data and the brand risk data can be structured data. Operating environment characteristics can relate to an operating environment of a particular organization and the relation between the operating environment characteristics and the particular potential threat can be based at least in part on a type of business of the particular organization, a type of asset included in the operating environment, and/or a type of data handled using the operating environment, among other examples. The characteristics can include a known vulnerability included in at least some operating environments and the determined relation can identify that the known vulnerability potentially increases risks to one or more brands. The brand impact information can be collected from a plurality of sources. The brand impact information can relate to a plurality of potential threats to one or more brands and relations can be determined between each of the plurality of threats and at least one respective characteristic of operating environments. Data can be collected from a particular operating environment and the operating environment characteristic can be identified from the collected data. Further, a severity of the risk associated with the particular brand can be determined. A brand risk module can be implemented in a cloud-based computing environment in some implementations.

Some or all of the features may be computer-implemented methods or further included in respective systems or other devices for performing this described functionality. The details of these and other features, aspects, and implementations of the present disclosure are set forth in the accompanying drawings and the description below. Other features, objects, and advantages of the disclosure will be apparent from the description and drawings, and from the claims.

### EXAMPLE EMBODIMENTS

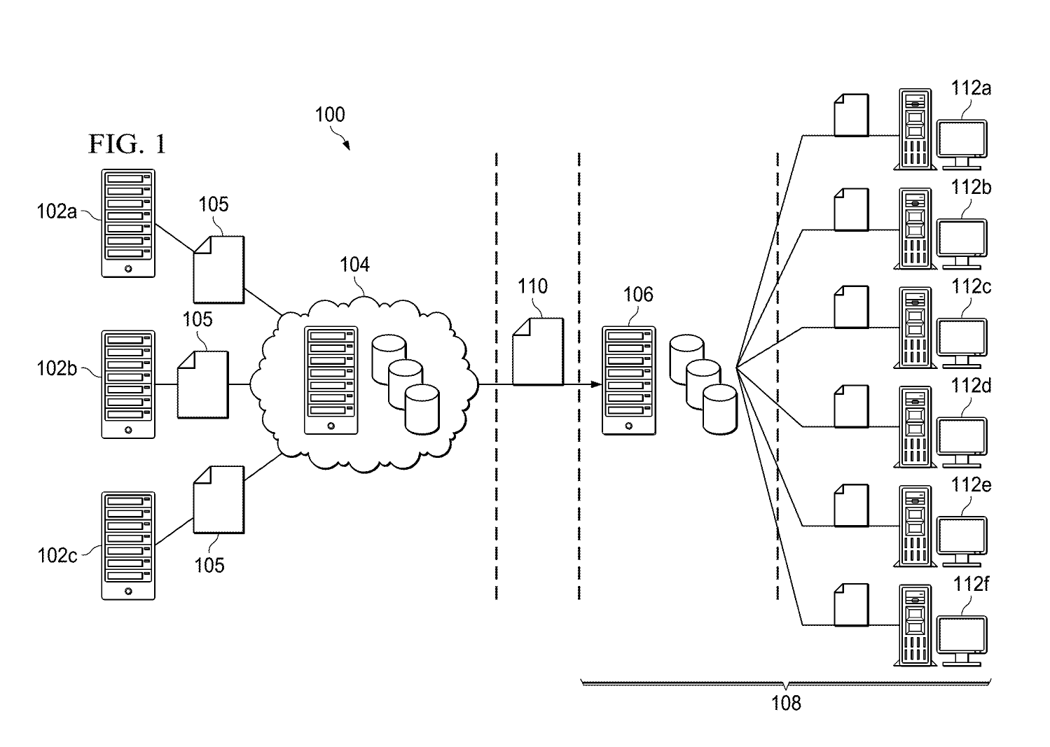

Turning to FIG. 1, FIG. 1 is a simplified architecture diagram of an example embodiment of a system 100 in which automated brand protection may be implemented. System 100 generally may include a brand risk intelligence system 104 that can include data collection tools and interfaces, such as automated data crawler tools and other computer-implemented tools, as well as tools operated by human analysts, who can discover and collect data, including unstructured data, from a wide variety of data sources (e.g., 102a, 102b, 102c). The data can include brand impact data 105 relating generally to potential brand-related risks threatening one or more operating environments. Further, a brand risk intelligence system 104 can also collect or access data (e.g., from data sources 102a, 102b, 102c or operating environment 108) describing various conditions within operating environments that correlate with, correspond to, or otherwise relate to the potential brand-related risks. In some instances, such operating environment conditions can be described or identified from the brand impact data 105 itself. For instance, a brand-related threat can be identified from brand impact data embodied in captured web data describing a news story relating to a security breach of a particular company's data casting negative light on the company and its brands, among other examples. A relation between the particular security breach, as well as conditions that caused or facilitated the breach, can be associated with the identified brand impact. Relationships can be identified for the brand impacts, or potential brand-related risks, identified in brand risk data 105 and conditions correlating with or causing the brand impact. Brand risk data 110 can be generated, collected, or otherwise maintained by brand risk intelligence system 104, the brand risk data 110 describing the identified relationships between brand-related risks and various operating environment conditions or characteristics.

Brand risk data (e.g., 110) can be stored in one or more data repositories, such as a cloud-based database system (DBS), maintained by brand risk intelligence system 104. A risk assessment system 106, such as a local risk assessment system 106 of a particular operating environment 108, can retrieve brand risk data 110 from brand risk intelligence system 104 or from a repository maintained by brand risk intelligence system 104, along with other risk data describing other non-brand risk factors associated with the operating environment (e.g., maintained locally by risk assessment system 106) and local data from assets associated with operating environment 108, such as system assets 112a-112f. System risk data, whether collected from centralized repositories, localized assets of the operating environment, or other sources can be used in connection with collected brand risk data 110 to generate, for example, risk scores and other analyses for the operating environment 108 incorporating and considering brand-related risk.

Before describing system 100 in detail, the following foundational information is provided as a basis from which the present disclosure may be explained. Such information is offered merely for purposes of illustrating certain example techniques for providing automated brand protection in example embodiments of system 100 and, accordingly, should not be construed in any way to limit the broad scope of the present disclosure and its potential applications.

Risk can be defined generally as the effect of uncertainty on objectives. The “uncertainties” can include events, a lack of information and/or ambiguity. In more specific contexts, such a definition may be refined to reflect singularities and particular characteristics of a particular application. For example, in enterprise risk management, risk may be defined as a measurement of the expected consequences of an event to an asset of the enterprise, based on the probability of an event occurring within a specific timeframe and the impact of the event if it were to occur. In other contexts, it may be defined as the relative impact that an exploited vulnerability would have on a particular environment.

An “event” broadly includes any activity, act, or failure to act that can affect risk, including the increasing, decreasing, triggering, or avoidance of risk. As one example, an event can include such activities as malware infecting a network or an employee failing to lock a door. An “asset” broadly includes any tangible or intangible thing of value, such as a customer, an employee, a business process, a document, a trade secret, a brand, goodwill, or an information technology system and its component devices and software, among other examples. The impact of an event may be observed in an asset, as well as other organizations, other system, society, markets, or the environment generally, etc. Further, the impact of an event can negatively impact the goodwill and brands of an affected organization.

Impact can be determined based on criticality of particular assets. Criticality can reflect the relative importance or value of a particular asset and the relative impact on an organization of a vulnerability or threat causing loss, damage, diminishment, or other impact to the particular asset. In analysis of risk, the impact can be based on the monetary or operational value of an asset. The common output from risk analysis can include, for example, a cost impact report, a process impact report, or a prioritization (order of operations) for reducing risk, based at least in part on the criticality of the assets affected by particular vulnerabilities or threat. As an example, some computing assets in an operating environment may be more important to the organization than other devices making the criticality of the more important (or critical) devices higher than the criticality of the less important devices. Further, in some examples, an enterprise's or organization's brand or goodwill can also be impacted by various threats or vulnerabilities facing the organization's operating environment, for instance due to bad press stemming from the threat or vulnerability or the effects of an exploit based on the threat or vulnerability. Traditional risk analysis techniques and asset criticality assessments neglect to consider the impact on an organization's brands or goodwill by various threats and vulnerabilities, and therefore fail to properly consider the full, potential impact (and risk) of various events threatening the organization and its operating environments. Indeed, in some industries, the value of an organization's brands and goodwill can account for a significant (and, in some cases, the largest) portion of an enterprise's overall value.

Methods for assessing risk may differ between contexts and risk analysis systems. For example, various algorithms and formulas used to calculate risk for a given operating environment can vary widely between industries and applications, such as whether risk pertains to general financial decisions, environmental, ecological, or public health risk assessments, or other factors. Traditional security risk assessment usually takes into account some combination of threats, vulnerabilities, assets, and countermeasures to formulate an overall security posture for some object or domain, such as a business organization, project, or network. More generally, risk assessment typically includes the determination of quantitative or qualitative value of risk related to a concrete situation and a recognized threat.

A “threat,” as used herein, can broadly refer to something that causes, attempts to cause, or potentially could cause a negative impact to an objective or an asset. For example, a threat may include malware that could disrupt business operations, a natural disaster, an organization that is targeting a person, industry, etc., or even a partner or vendor that has been compromised. A “vulnerability” generally includes any weakness or condition that can be affected or exploited by a threat. A vulnerability may include, for example, misconfigured software or hardware; an employee susceptible to manipulation, temptation, or persuasion; inadequate security measures, password protections, etc., or a facility housing the system and assets not being equipped with adequate security measures such as fire extinguishers, locks, monitoring equipment, etc. A “countermeasure” is anything that can mitigate a vulnerability or threat, such as antivirus software, intrusion protection systems, a software patch, a background check, or even a lock on a door.

Quantitative risk assessment, in some instances, evaluates both the magnitude of the potential impact (e.g., loss or harm) to an asset, and the probability that an event will cause the impact. The combination of these components can be used to create a risk metric that is both forward-looking and has predictive capabilities. The ability to predict allows for identification of risk metrics relating to various assets within an operating environment or the operating environment as a whole, as well as allowing for prioritization of tasks to reduce risk in connection with risk management of the operating environment.

In risk management, a prioritization process can be followed whereby the risks with the greatest impact and the greatest probability may be handled first, with risks of lower probability and potential loss are handled in descending order. In practice, the process of assessing overall risk can be difficult, and balancing resources used to mitigate between risks with a high probability of occurrence but lower impact versus a risk with high loss but lower probability of occurrence can often be mishandled. Methods and processes for managing risk can include identifying, characterizing, and assessing threats; assessing vulnerability of assets to specific threats; determining the risk to specific assets based on specific vulnerabilities and threats; and implementing strategies for reducing or eliminating the risk.

However, risk assessment using such criteria can be quite theoretical in the sense that it does not generally attempt to factor in information regarding past or current events. Nor does it factor in impact to “brand” (i.e., goodwill or reputation) based on events. If an event has occurred, it would be beneficial for a risk manager to understand if there is external evidence that the event led to something that externally affected an objective (e.g., increasing or maintaining value of asset). For example, if a company may be vulnerable to a botnet attack that could result in sending out spam, causing the company's domain to be blacklisted, it would be beneficial for the company to be able to correlate the fact that a specific threat could lead to a specific exploit that could lead to a specific case of loss (i.e., loss to reputation). Likewise, if it was determined that there was media coverage indicating the company was responsible for sending out spam, that information should be identified as potentially elevating the risk to the company's brand and thereby the overall risk to the company.

In accordance with embodiments disclosed herein, a system and method is provided for automated brand protection. In more particular embodiments, a method may be provided that can correlate potential risk with active exploits to assess risk to a brand based on the active exploits and other conditions of a related operating environment. An automated brand protection system may, for example, implement a technique for associating threats with exploits using data from multiple, heterogeneous sources. It can identify various aspects of brand impact due to an exploit using multiple data sources, and can relate this brand impact (or potential impact) back to a specific threat.

In some embodiments, system 100 may use a mapping technique that can identify common exploits from various security products that detect exploits in progress (e.g., intrusion detection systems, intrusion prevention systems, antivirus software, data loss prevention systems, etc.) and associate such exploits with enterprise-level (or even individual-system-level) threats. Security products and services can also identify common exploits affecting other systems outside of system 100, such as other third-party systems having similar components and applications or managed by similar organizations. Further system 100 can filter out data describing duplicate exploits and exploits to the most prevalent or publicized threats, as well as threats most relevant to a brand. Identified threats can then be compared against other organization- or system-specific data to identify that a particular threat or vulnerability potentially affects a related organization. Further data can be analyzed to determine or predict that a brand of the organization may be linked to and impacted by one or more identified exploits, vulnerabilities, and threats. For instance, once a vulnerability has been exploited, other cloud-based or real-time data can be queried to determine if the exploit may negatively affect a brand by virtue of the exploit being linked to some publicized attack and potentially resulting in negative public relations exposure for the brand, among other examples.

System 100 can, in some implementations, include tools and subsystems adapted to collect and categorize intelligence about how a particular threat might impact a brand, and distribute this intelligence to other tools or use this intelligence itself to determine risk to a brand. As noted above, in some implementations, brand risk intelligence system 104, or other tools, can be provided that generate, collect, and maintain brand risk data 110 stored, in some implementations, in one or more data repositories accessible to one or more risk assessment systems (e.g., 106) adapted to use such brand risk data to determine brand-related risk for one or more particular, corresponding operating environments. Brand risk data can define how damage can potentially be inflicted upon a brand or goodwill of an organization due to various threats facing an operating environment or an organization associated with the operating environment. For instance, threats to a given industry, threats to a particular business, threats to a particular information technology system of organization (e.g., based on the type of software and/or hardware used in a particular organization), or an exploit of vendor, competitor, or other related organization or system, among other examples, can be identified in brand risk data 110 associated with potential threats or damage facing brands related to an organization and its operating environment(s). Further, data can be collected and maintained cataloguing a variety of threats, vulnerabilities, countermeasures (e.g., antivirus, host intrusion protection, network intrusion protection, whitelisting, etc.), and cataloguing particular characteristics of various computing and operating environments, including operating environments of a plurality of different third parties.

Vulnerabilities, threats, system device configurations, owner identity information, geographical data, and other characteristics of an operating environment can be described in data collected and otherwise maintained by an example brand risk intelligence system 104. Moreover, brand risk intelligence system 104 also may maintain data for use in proximity analyses, such as known or rumored exploits, targets, origins, last occurrences, frequency, etc. As an example, a given exploit may target the financial services industry with a certain threat vector (e.g., network exploit that doesn't require local access, or requires visiting malicious website), and this exploit may be stored in a database or other data structure maintained by brand risk intelligence system 104 along with information that identifies exploited targets and the frequency of exploits. The information in such data can be used, for example, to map out the life cycle of a threat and perform pattern recognition. This data can be further used to map particular exploits, vulnerabilities, threats, or other characteristics or issues that may exist in an operating environment to particular brand-related threats. The associations of particular operating environment characteristics with particular brand-related threats can be defined or described in brand risk data generated by and/or stored by the brand risk intelligence system 104.

Tools in system 100 may be provided that allow the distribution of brand risk data 110 to one or more client systems and risk assessment systems, such as a particular risk assessment system 106 used in the monitoring and risk management of a particular operating environment 108. In some implementations, repositories of brand risk data can be centrally developed and maintained and that can be served or otherwise provided to a plurality of different risk assessment tools, including risk assessment tools employing a variety of different risk assessment algorithms, goals, and functionality and used in a plurality of different operating environments. Indeed, a repository of brand risk data can be developed as a resource or service for consumption by a variety of different risk assessment tools, and corresponding APIs can be provided allowing such risk assessment tools to query and access brand risk data, as well as brand impact data and other resources maintained by an example brand risk intelligence system 104. Each risk assessment tool can be used, for instance, to determine the relevance of particular brand-related threats described in brand risk data and filter that data that is relevant to its corresponding operating environment. Further, risk assessment tools and systems (e.g., 106) can collect, receive, or otherwise access data from an associated operating environment and assets within the environment to identify attributes of the operating environment. The risk assessment tools and systems can then compare information from the data, including operating environment risk information, to brand-risk intelligence of the brand risk data to determine potential impacts to a brand, such as a brand affiliated with an organization controlling the particular operating environment.

In some embodiments, brand risk data and other data may be stored in a cloud-based repository. In general terms, a cloud-based repository can include an environment providing on-demand network access to a shared pool of computing resources that can be rapidly provisioned (and released) with minimal service provider interaction. It can provide computation, software, data access, and storage services, for instance, that do not require end-user knowledge of the physical location and configuration of the system that delivers the services. A cloud-computing infrastructure can consist of services delivered through shared data-centers, which may appear as a single point of access. Multiple cloud components can communicate with each other over loose coupling mechanisms, such as a messaging queue. Thus, the processing (and the related data) is not in a specified, known or static location. A cloud-based repository may encompass any managed, hosted service that can extend existing capabilities in real time, such as Software-as-a-Service (SaaS), utility computing (e.g., storage and virtual servers), and web services.

In more particular example embodiments, a method for automated brand protection may include a scoring algorithm to quantify the overall security posture of an organization, including risk to an organization's operating environment, subsystems within the environment, and assets within the environment, and further consider the security profile relative to the organization's brand. For instance, a scoring algorithm, in one particular example, may factor-in potential risk, actual risk, and brand impact to calculate the overall assessment of risk to an operating environment. In one particular embodiment, a risk score may be calculated as (T*V*A)/C*E*B, where T quantifies a threat, V quantifies a vulnerability, A quantifies an asset, C quantifies countermeasures, E quantifies properties of an exploit, and B quantifies brand impact. Thus, threats that lead to an exploit that potentially affect an organization's brand may be scored higher than exploits that do not, or have a lesser potential impact on an organization's brand. For instance, threats known to have led to an exploit but not identified has having a profound effect on the brand may be scored lower, as B, in this example, would have a lower value. In other cases, both E and B may have lower values, for instance if a threat has been identified but no exploits have been detected or exploits are in categories not related to a particular organization, etc.

In some instances, in addition to identifying that a brand-related threat is potentially relevant to risk assessment of a particular organization and its operating environments, the severity of a brand-related threat can also be estimated or determined and factored-in to the risk assessment. For instance, in one example embodiment, a brand risk intelligence system 104 can measure risk to a brand with two components. The first component can be the valuation of the brand, which may be provided as user-defined input in some instances. The second component can be the rate of exploitation affecting the brand. Further, in some embodiments, the relevance or severity of an exploit to a brand can be determined by enhancing or modifying existing risk assessment systems, including standardized risk scoring systems such as the Common Vulnerability Scoring System (CVSS). For instance, in the example of CVSS, a set of impact metrics can be provided that allow vulnerabilities to be compared against each other in standardized ways, including a base metric group, a temporal metric group, and an environmental metric group. In the example of CVSS, a base metric group represents the intrinsic and fundamental characteristics of a vulnerability that are constant across time and environments; a temporal metric group represents characteristics of a vulnerability that change with time but not across environments; and an environmental metric group represents the characteristics of a vulnerability that are relevant and unique to a particular environment. When the base metrics are assigned values, a base equation provides a base vulnerability score. In one implementation, a standardized or base vulnerability or risk score, such as a CVSS base score can be augmented to consider brand-related risk, such as described in brand risk data generated or collected by brand risk intelligence system 104. For instance, in one example, impact metrics can be included in a standardized risk calculation, as in CVSS, that measure how a vulnerability, if exploited, can affect an asset. In the example of CVSS, impacts can be defined, for instance, as the degree of loss of confidentiality (C), integrity (I), and availability (A). For example, a vulnerability could cause a complete loss of availability, but no loss of integrity or confidentiality, such as if a vulnerability is exploited to cause a denial of service. In one example embodiment implementation, impact metrics of a standardized risk assessment algorithm could be augmented to use brand risk intelligence by customizing the impact metrics with a brand impact metric, which can be incorporated into the standardized risk base equation, among other potential examples.

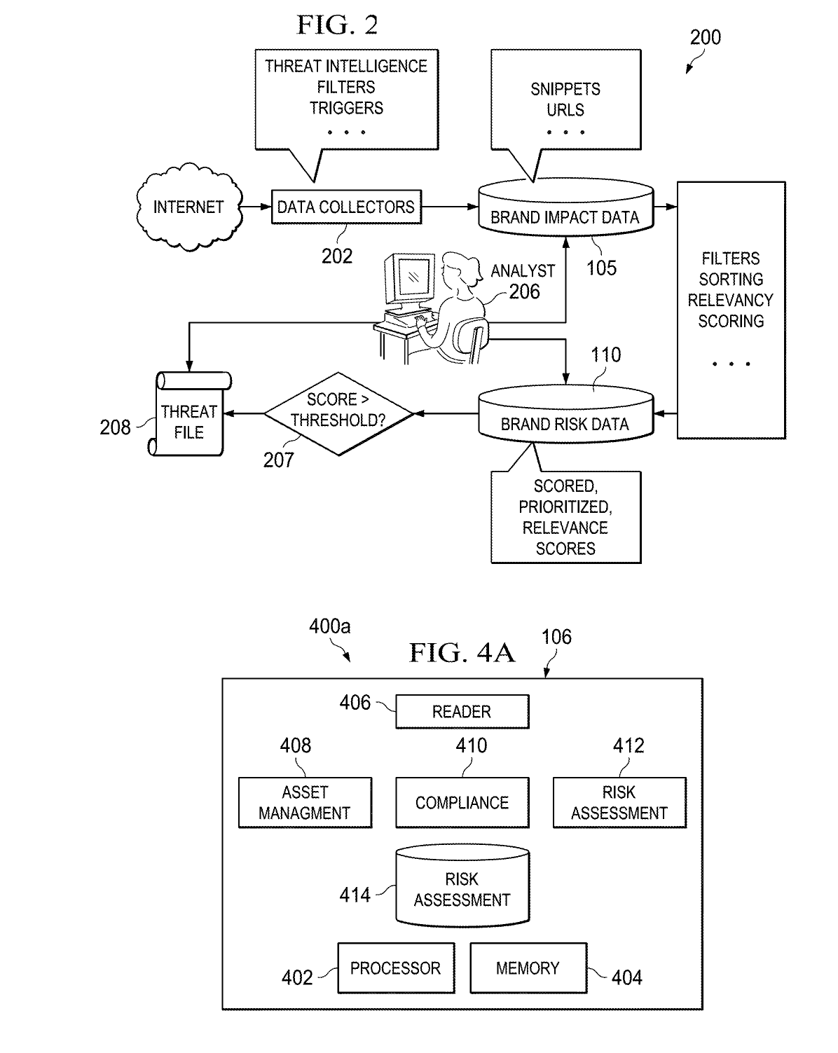

FIG. 2 is a simplified data flow diagram 200 illustrating additional details that may be associated with an example embodiment of system 100. In this example embodiment, data collectors 202 (e.g., in connection with brand risk intelligence system 104) may monitor the Internet to collect brand impact intelligence for malware and other threats. For example, data collectors 202 may use threat intelligence resources, filters, triggers, and keywords to identify potentially relevant intelligence sources, such as online news articles, websites, forums, blogs, and social media posts, and other data that identify real or potential of organizations or even other organizations in related fields. For instance, message boards, social networks, online message feeds, etc. popular with hackers or IT professionals can be monitored for references to various threats, attacks, and vulnerabilities affecting, or potentially affecting, particular named organizations, brands. For example, through such scanning threat intelligence can be developed that identifies, for instance, a phishing threat that includes fraudulent emails falsely claiming to be from a reputable organization, and a keyword may identify a particular brand (e.g., in a URL or subject line) being abused by the phishing threat. Such data representing this intelligence can, for example, be collected and stored in unstructured form, such as in brand impact data 105. Brand impact data 105 may, for example, include copies or snippets of sources, along with uniform resource locators associated with each source.

Brand impact data 105 can be categorized (e.g., by type of threat and operating environment), filtered, sorted, scored for relevance, and converted to structured data that may be stored in a repository, such as database maintained by brand risk intelligence system 104. Such data may also include reputation data (e.g., reputation associated with IP addresses), among other examples. In some embodiments, a user interface can be provided to a human analyst, such as analyst 206, allowing the user to introduce manually-collected brand impact data, as well as define filters, sorts, scoring rules, and other parameters for use in converting unstructured brand impact data 105 into structured brand risk data 110. Additionally, an analyst 206 can interact with brand risk data 110 to perform quality control on the collected data 110, provide additional context (e.g., in filters, scores, sorts, of the data), etc. to further improve the quality of the automatically-collected and -structured data, among other examples and tasks.

Brand risk data 110 can be further processed to assess whether the brand risk data 110 identifies conditions representing a real or potential threat to one or more brands. In some examples, brand risk data 110 can be scored, based on the severity and reliability of the threats identified in the brand risk data, and brand risk data 110 exceeding one or more particular thresholds (or meeting other conditions) can trigger creation of a threat file 208 or other data structure. A threat file 208 can be utilized, for instance, by human users as well as risk assessment tools and systems, for instance, in connection with a risk assessment of a system, among other examples. Further, in some examples a user interface can be provided to a human analyst (e.g., 206) to identify and review brand risk intelligence embodied in brand risk data 110 that exceeds a threshold relevancy score. The user (e.g., 206) can then further augment or modify a copy of the brand risk data 110, or generate additional data, to include a brand impact score indicating a determined brand-related risk to an operating environment based on the identified brand risk intelligence. In one example, such user-generated information can be included in a corresponding threat file 208. In further embodiments, threat files 208, upon generation, can be presented to users (e.g., 206) for further review, as an alert, etc.

In some embodiments, filters, triggers, keywords, and/or other criteria may be specified by one or more particular operating environments and applied at various stages of data flow 200. For example, some triggers may be specified by particular operating environments and applied by data collectors 202 before collecting, storing, or otherwise using brand impact data 204, while other filters may be applied (e.g., by risk assessment systems) when calculating relevancy scores for structured brand risk data 110, such as stored in a database system (DBS). Additionally or alternatively, default or system-specific criteria and algorithms may be applied to generate threat file 208 from brand risk data obtained from a DBS, such as criteria defined by one or more analyst users (e.g., 206).

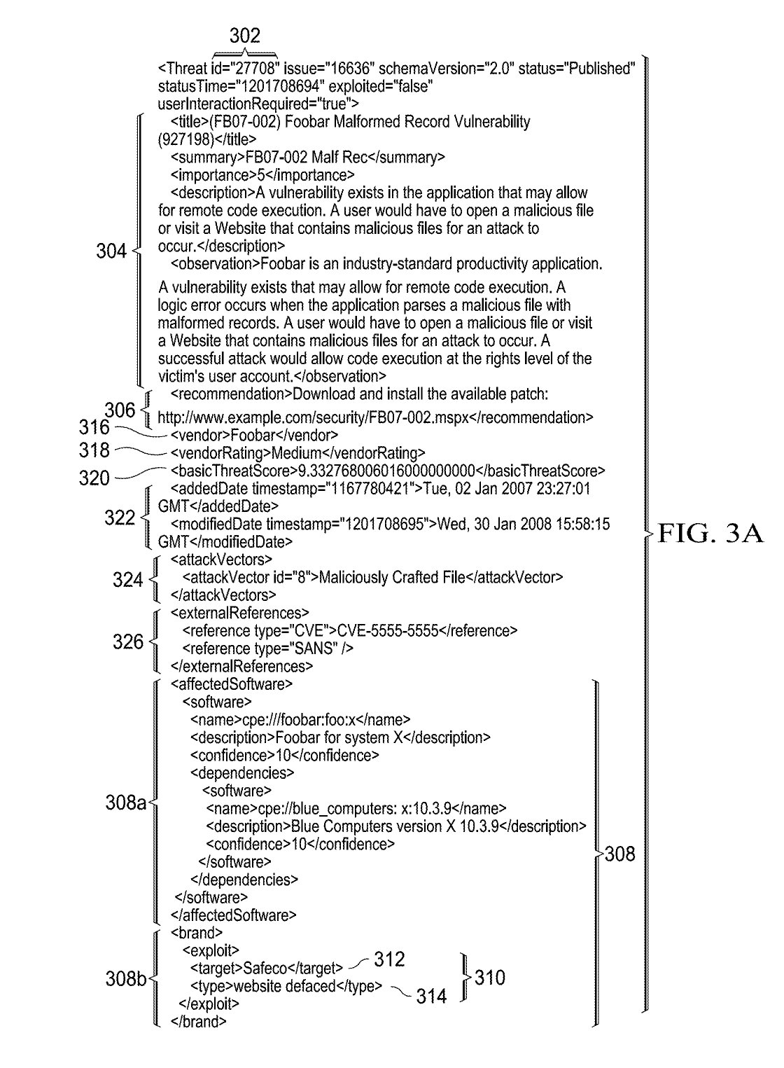

FIGS. 3A-3B are at least a partial listing of an example embodiment of a threat file 208. In this particular example, the threat file 208 is implemented in an extensible markup language (XML) format. FIG. 3A is a listing that includes a threat identifier 302, a general description 304 associated with a threat, a recommended action 306 for the threat, and a listing 308 of affected assets, such as software 308a and the listing of a potentially affected brand 308b. Brand 308b can, for example, identify properties of an exploit 310, such as a target 312 (e.g., a company named “Safeco”) and an exploit method 314 (e.g., defacing a website, email, botnet, virus, etc.). Other exploit properties or attributes may include a type of organization (e.g., industry), type of asset exploited, frequency, type of data compromised, destination (e.g., fraudulent URL), source (e.g., botnet name, fraudulent URL), and/or motivation, for example. Additional information may include a vendor identifier 316, a vendor rating 318 of the threat, a basic threat score 320, time and date records 322, an attack vector 324, and external references 326.

FIG. 3B is a listing that illustrates CVSS records 328 in an example XML threat file 208. In this example, threat file 208 provides a vendor-specific CVSS record 328a and a standardized CVSS record 328b (e.g., a National Vulnerability Database (NVD) record). CVSS records 328a-328b may each include a threat vector 330a-330b and scores 332a-332b, respectively. In the example of FIG. 3B, threat vector 330a additionally includes a brand metric (B), which can be modified within an operating environment to account for specific assets and other environmental factors. Scores 332a-332b may include base scores 334a-334b, environmental scores 336a-336b, exploitability scores 338a-338b, impact scores 340a-340b, and temporal scores 342a-342b. Values for base metrics 344a-344b are also provided in the example of FIG. 3B. Base metrics 344a also include a brand impact metric 346, which can be modified within an operating environment to account for specific assets and other environmental factors.

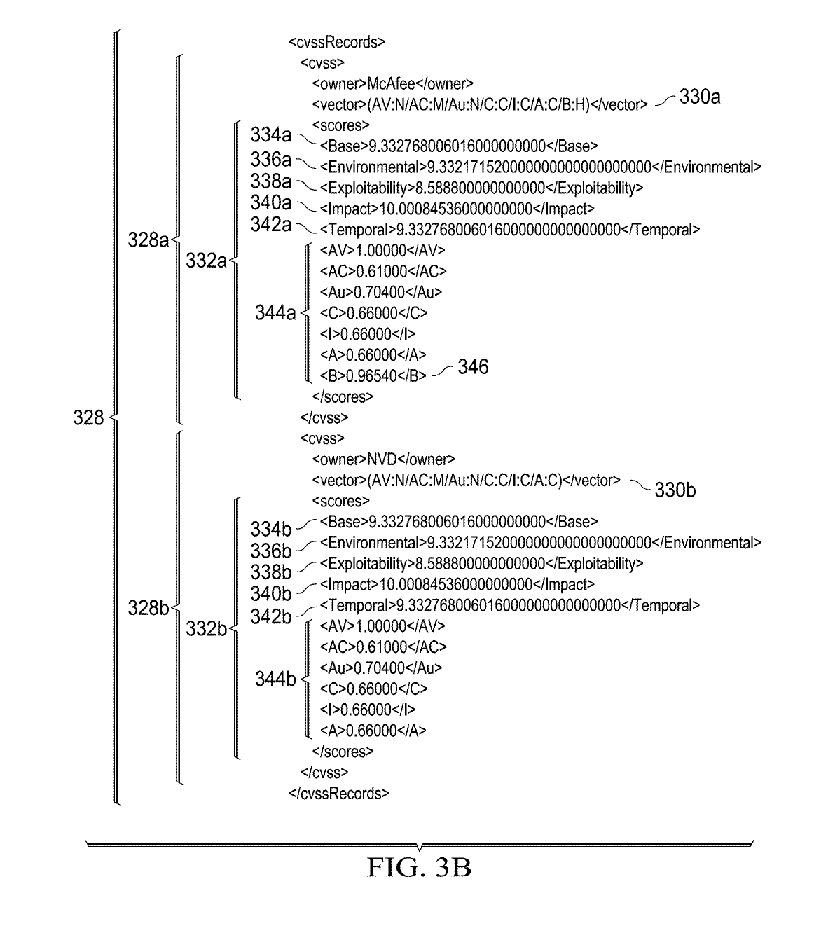

A threat file such as threat file 208 may include additional information, which may also be provided in an XML format in some embodiments. For example, threat file 208 may include compliance records that describe relevant technical standards (e.g., ASCII), statutory and/or regulatory requirements (e.g., HIPAA), industry standards, and/or other policies. Other information may include disclosure history and/or requirements, exploits, mitigation procedures, and vulnerability assessment procedures, among other examples. FIG. 4A is a simplified block diagram 400a that illustrates additional details that may be associated with an example embodiment of a risk assessment system 106 in operating environment 108 of system 100. Risk assessment system 106 may include a processor 402 and a memory element 404, and may additionally include various hardware, firmware, and/or software elements to facilitate operations described herein. More particularly, risk assessment system 106 may additionally include a reader module 406, an asset management module 408, a compliance module 410, and a risk assessment module 412. Risk assessment system 106 may also include a risk assessment database 414, among other components.

In general terms, reader module 406 can be adapted to periodically retrieve updated threat intelligence data, which includes brand risk data. For example, a repository hosted or maintained by a brand risk intelligence system 104 may be a repository that gets passed to a front-end data feed in some embodiments, and reader module 406 can retrieve intelligence data from the data feed (e.g., as one or more XML documents) and convert the data into a relational format for storage in risk assessment database 414. For example, reader module 404 can break the data into data domains that contains categories (e.g., threat, vulnerability, countermeasure, etc.). Asset management module 408 may also maintain a repository of assets 112a-112f (e.g., websites, servers, workstations, etc.) and/or criticality of assets. Assets may also include human resources, partners, and intangible brand-related assets, such as trademarks, trade secrets, and other abstract representations of an organization to the public. Moreover, asset management module 408 may collect vulnerability and event data for assets. For example, asset management module 408 may use network and host vulnerability scanners to detect vulnerabilities, data loss protection systems can be used to collect event data for copying/printing data, and web proxies can be used to collect event data for suspicious or harmful web activity. Compliance module 410 can collect policy compliance data for assets. Risk assessment module 412 may analyze incoming brand risk data and rank it according to local information, such as industry, type of business, or classes of assets within operating environment 108, as defined in data generated and collected, for example, by asset management module 408 and compliance module 410.

As brand risk data can include information such as the potential brand impact based on type of business, type of asset, type of data, type of exploit, business relationships, and/or geopolitical factors, identifying relationships between brand risk data and various system characteristics can be used to identify an asset's or the operating environment's proximity to a brand-related threat defined in brand risk data and align the brand risk data to the particular operating environment 106. Moreover, data describing characteristics of an operating environment can be collected or be focused on individual assets within the operating environment. Such information can also be compared against brand risk data to not only identify proximity to certain brand-related risks but to also identify where (e.g., a particular asset or group of assets) in the operating environment significant threats to a brand exist. Further, risk assessment system 106 can also provide feedback to system 100, such as to brand risk intelligence system 104. For example, tools in a customer operating environment (e.g., risk assessment system 106) can provide real-time (or near real-time) reports of actual attacks/exploits detected in the operating environment, along with the types of systems in place and other characteristics of the operating environment, to the brand risk intelligence system 104. Such feedback can also include information indicating brand impacts at the operating environment level. Such feedback data can then be used by brand risk intelligence system 104 in the development of additional brand risk data, including brand risk data that can be used by other, third party operating environments, among other examples.

Turning to FIG. 4B, a simplified block diagram 400b is shown illustrating additional details that may be associated with an example embodiment of a brand risk intelligence system 104 of system 100. Brand risk intelligence system 104 may include a processor 420 and a memory element 422, and may additionally include various hardware, firmware, and/or software elements to facilitate operations described herein. More particularly, in one example implementation, brand risk intelligence system 104 may include data collector modules 202, a risk data generation module 424, and client interface module 426, among potentially other modules and tools.

Generally, as described above, data collector modules 202 can include tools adapted to identify and collect data from a variety of sources, both public and private, that identify organizations' brands and potential threats facing the brands. Such brand impact data 105 can include unstructured, or in some cases, structured data. Data collector modules 202 can also collect or identify data, including feedback data and other data from customer systems or risk assessment tools, describing various operating environment characteristics. An example risk data generation module 424 can be used to identify commonalities between potential threats facing brands (and identified in brand impact data) and particular characteristics associated with and potentially causing or correlating with these brand-related threats, including computing system vulnerabilities, features, and configurations, industry type, geographical location, business type, time of year, among other characteristics. Further, a risk data generation module 424 can be adapted to generate brand risk data 110 identifying these associations between operating environment characteristics and brand-related threats. Databases and other repositories can be maintained by an example brand risk intelligence system 104 and can be served or made accessible through an example client interface module 426. An example client interface module can additionally include functionality for managing a plurality of different customer systems, such as a plurality of different risk assessment tools, operating environments, customer organizations and the like. Further, client interface module 426 can be additionally adapted to accept data from customer systems, such as feedback data received from example risk assessment tools (e.g., 106).

A variety of different brand-related threats can be identified in brand impact data and associations between a wide variety of different operating environment characteristics. The brand-related threats defined in brand risk data can be just as varied and diverse. For instance, in one particular illustrative example, a hack of customer database of a first travel service provider may have resulted in the theft of customer data, with various news outlets reporting the breach and naming one or more brands of the first travel service provider in the reporting. Data collectors of a brand risk intelligence system (e.g., 104), can detect websites and other digital resources referencing the reported breach. For instance, data collectors can crawl the Internet, or particular sites or services on the Internet for mentions of known brand names, known threats or vulnerabilities, stock price, earnings, or other market fluctuations, news, and other information. Further, collected brand impact data can be identified from the collected data as relating to and describing conditions of a particular brand-related threat, in this example, identifying the brand name(s) of the first travel service provider, the presence of negative media attention, the cause of the negative media attention (i.e., the hack), etc.

Data collected by a brand risk intelligence system 104 can be identified as brand impact data either automatically (e.g., based on content recognition algorithms applied by the data collectors) or manually by human analysts reviewing the collected data or filtered sets of the collected data. Additionally, further information can be identified pertaining to the identified brand-related hack of the first travel services provider. Such information may be identified from the brand impact data itself or from other data, including data gathered from systems of the first travel services provider or other victims of similar hacks describing various conditions and characteristics of the affected systems, such as particular vulnerabilities of the affected systems exploited by the hack. Such information can be used by a brand risk intelligence system 104 to generate brand risk data identifying a particular brand-related threat (e.g., a hack that resulted in negative publicity for a brand) associated with particular system characteristics. In the above example, such characteristics could include the system configurations associated with vulnerabilities exploited in the hack, an identification that travel-related businesses were attacked, that businesses located in a particular geographical region or network were attacked, that businesses of a certain size or economic profile had been attacked, among other operating environment characteristics. Such characteristics identified in brand risk data for a particular brand-related threat can be used to identify other organizations and corresponding operating environments with common or similar characteristics that appear to thereby be more likely endangered by the identified brand-related threat. For instance, if an second organization is in the same industry as the first travel services provider, is a vendor or customer of the first travel services provider, or otherwise associated in the marketplace with the first travel services provider, it can be determined that the risk to the second organization from the hacking threat is elevated (i.e., relative to other non-travel-related marketplace participants) based on brand risk data describing the hacking threat. Additionally, other characteristics of the second organization can be identified and compared against brand risk data to determine that risk should be elevated based on the brand-related hacking threat (i.e., even when the second organization is unrelated to the first travel services provider in the marketplace). For instance, brand risk data can identify that the presence of a particular vulnerability within an operating environment, such as in a network of the second organization, elevates the risk to the second organization from the hacking threat. Accordingly, risk analyses and scores generated for the second organization and its operating environments can incorporate this determined heightened risk, thereby showing the elevated risk due to potential impacts to the second organization's brands.

In some implementations, risk assessment tools can generate brand-specific risk scores from comparisons of operating environment characteristics and brand risk data determined to be relevant to the operating environment. A brand-specific risk score or metric can indicate an amount of risk facing a particular brand of an organization. In other instances, a brand-specific risk score can be a component of an aggregate risk score for an organization, computing system, operating environment, etc. and represent the portion of overall risk attributable to risk facing one or more brands. Similarly, brand risk score components can also be based on brand risk data obtained for one or more brand-related threats as compared against characteristics of the organization, environment, or systems for which risk is measured.

In some instances, determining brand-related risk can include determinations of the proximity of a particular asset, system, organization, or operating environment to a particular brand-related threat. Proximity vectors to a particular threat can be based on determining a degree of correlation between an organization's, system's, or environment's own characteristics and the characteristics defined as associated with a brand-related threat in brand risk data. In some instances, proximity and degree of correlation thresholds and other information can be defined in the brand risk data for use in determining or guiding determinations of proximity of a brand-related threat. For instance, returning to the illustrative example above, a company in a different but similar industry as a first travel services provider can be determined to have a lesser proximity to the brand-related hacking threat than another company within the same industry as the first travel services provider. Temporal proximity to a brand-related threat can influence a determination of proximity, for instance, with proximity and risk decreasing as time progresses from a last-detected exploit involving a particular brand-related threat.

In addition to proximity, brand-related risk calculations can also factor in criticality or value of the affected brands. The amount of determined risk attributable to a threat to a brand can be proportional or dependent on the value of the affected brand(s) and/or the amount of damage predicted to be inflicted by the identified brand-related threat. Value of a brand can be based on data internal to an organization or operating environment and accessed by a risk assessment system in the determination of brand-related risk. Estimated damage to a brand can be based on one or both of organization-specific information or brand risk data identifying, for instance, historical impact on brands affected by the corresponding threat, among other examples.

In addition to the examples above, a variety of other types of brand-related threats can be identified and corresponding brand risk data generated. In another illustrative example, brand risk data can be based on brand impact data that, instead of identifying instances of negative public relations, monitors and reports unauthorized uses of a particular brand that could be used to damage goodwill attributable to authorized use of the brand. For instance, data identifying traffic associated with spoofing attacks, phishing schemes, black market sales, trademark infringement, unauthorized domain name uses, unauthorized vendors, or other wrongful uses of a brand can be identified by data collectors and used, as brand impact data, by a brand risk intelligence system. As but one of many potential examples, a spoofing attack can be identified involving unauthorized users masquerading as a particular company, their actions potentially damaging the brand of the particular company. In another example, an attack can involve spoofers utilizing devices, networks, or IP addresses of an organization without authorization to launch attacks on other systems, thereby damaging the brand of the organization whose system was infiltrated and used by the attackers (and potentially blocked or blacklisted downstream). IP addresses of botnets, servers, and other computing devices and systems used in the spoof attack can be identified as characteristics of the brand-related attack, along with characteristics discussed above, such as system configuration information, industry type, geography, etc., among other examples.

With regard to the internal structure associated with elements of system 100, each can include memory elements (e.g., as shown in FIGS. 4A and 4B) for storing information to be used in the operations outlined herein. Moreover, each element may include one or more interfaces, and such interfaces may also include appropriate memory elements. Each element may keep information in any suitable memory element (e.g., random access memory (RAM), read-only memory (ROM), erasable programmable ROM (EPROM), electrically erasable programmable ROM (EEPROM), application specific integrated circuit (ASIC), etc.), software, hardware, or in any other suitable component, device, element, or object where appropriate and based on particular needs. Any of the memory elements discussed herein should be construed as being encompassed within the broad term “memory element” or “memory.” Information being used, tracked, sent, or received could be provided in any database, register, queue, table, cache, control list, or other storage structure, all of which can be referenced at any suitable timeframe. Any such storage options may be included within the broad term “memory element” or “memory” as used herein.

In certain example implementations, the functions outlined herein may be implemented by logic encoded in one or more tangible media (e.g., embedded logic provided in an ASIC, digital signal processor (DSP) instructions, software (potentially inclusive of object code and source code) to be executed by a processor, or other similar machine, etc.), which may be inclusive of non-transitory media. In some of these instances, memory elements can store data used for the operations described herein. This includes the memory elements being able to store software, logic, code, or processor instructions that are executed to carry out the activities described herein.

In one example implementation, elements may include firmware and/or software modules to achieve, or to foster, operations as outlined herein. In other embodiments, such operations may be carried out by hardware, implemented externally to these elements, or included in some other network device to achieve the intended functionality. Alternatively, these elements may include software (or reciprocating software) that can coordinate in order to achieve the operations, as outlined herein. In still other embodiments, one or all of these devices may include any suitable algorithms, hardware, firmware, software, components, modules, interfaces, or objects that facilitate the operations thereof.

Additionally, each element may include one or more processors (or virtual processors) that can execute software or an algorithm to perform activities as discussed herein. A processor, virtual processor, logic unit, or other processing unit can execute any type of instructions associated with the data to achieve the operations detailed herein. In one example, a processor could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), an EPROM, an EEPROM) or an ASIC that includes digital logic, software, code, electronic instructions, or any suitable combination thereof. Any of the potential processing elements, modules, and machines described herein should be construed as being encompassed within the broad term “processor.”

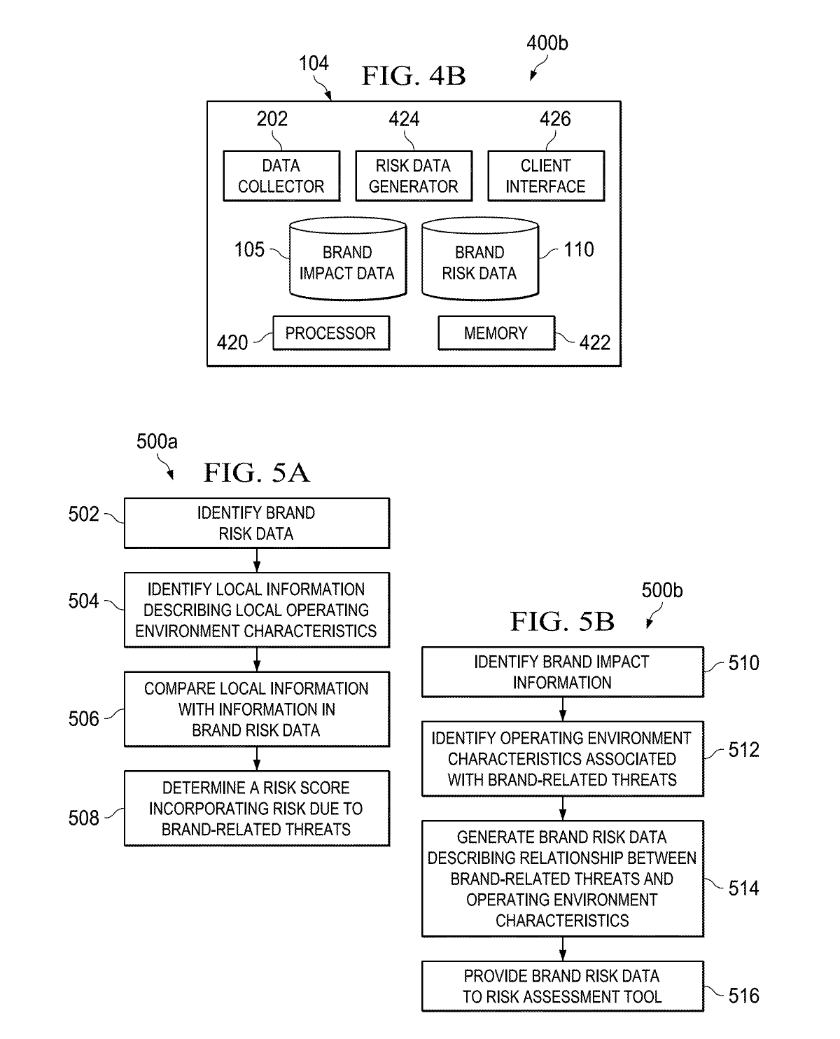

FIG. 5A is a simplified flow diagram 500a that illustrates potential operations that may be associated with example embodiments of system 100, such as risk assessment systems within system 100. For instance, at 502, brand risk data may be received, identified, obtained, or otherwise accessed. For example, brand risk data may be received from an XML feed as a threat file in one particular embodiment. At 504, local information specific to an operating environment can be retrieved and aligned with the brand risk. In some instances, local operating environment information may be retrieved from a risk assessment database maintained in connection with the risk management of the operating environment. The local information may identify an industry or type of business associated with the operating environment, identify specific classes of assets, system configurations, and other operating environment characteristics. At 506, characteristics described in the local information describing the assessed operating environment can be compared with the characteristics identified in brand risk data to identify potential brand threats relevant to or likely affecting the assessed operating environment. Further, at 508, in some implementations, a risk score can be calculated for at least a portion of the assessed operating environment and accounting for identified brand threats potentially affecting the assessed operating environment.

Turning to FIG. 5B, a simplified flow diagram 500b illustrating potential operations that may be associated with example embodiments of system 100, such as brand risk intelligence systems within system 100. For instance, at 510, brand threat data can be collected, generated, or otherwise identified that describes information relating to potential threats to one or more brands. At 512, one or more characteristics of an operating environment or collection of operating environments can be identified that relate to the identified potential threats, and a relationship between an identified characteristic and an identified brand-related threat can be defined in brand risk data generated at 514. Such a relation can be based on a correlative relationship between a characteristic and a threat, a predicted or verified causal relationship a characteristic and a threat, or other relationship tying an operating environment characteristic to a brand-related threat. Further, in some implementations, brand risk data generated based in part on collected brand impact data can be provided, served, or otherwise made accessible, at 516, to risk assessment tools that can utilize the brand risk data in the identification of brand-related risk facing an assessed organization, operating environment, asset, brand, subsystem, or other entity.

Note that with the examples provided above, as well as numerous other potential examples, interaction may be described in terms of two, three, or four network elements. However, this has been done for purposes of clarity and example only. In certain cases, it may be easier to describe one or more of the functionalities of a given set of operations by only referencing a limited number of network elements. It should be appreciated that system 100 is readily scalable and can accommodate a large number of components, as well as more complicated/sophisticated arrangements and configurations. Accordingly, the examples provided should not limit the scope or inhibit the broad teachings of system 100 as potentially applied to a myriad of other architectures. Additionally, although described with reference to particular scenarios, where a particular module, such as an analyzer module, is provided within a network element, these modules can be provided externally, or consolidated and/or combined in any suitable fashion. In certain instances, such modules may be provided in a single proprietary unit.

It is also important to note that the steps in the appended diagrams illustrate only some of the possible scenarios and patterns that may be executed by, or within, system 100. Some of these steps may be deleted or removed where appropriate, or these steps may be modified or changed considerably without departing from the scope of teachings provided herein. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by system 100 in that any suitable arrangements, chronologies, configurations, and timing mechanisms may be provided without departing from the teachings provided herein.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

1-27. (canceled)

28. A method comprising:
identifying brand threat information relating to potential threats to one or more brands;
identifying a characteristic of one or more operating environments; and
determining a relation between a particular one of the potential threats and the characteristic;
wherein the determined relation is used in a determination of risk associated with a particular brand of an organization.

29. The method of claim 28, further comprising determining a brand risk score for the particular brand based at least in part on the determined relation.

30. The method of claim 29, further comprising generating a composite risk score for an operating environment based at least in part on the brand risk score and at least one other risk score component.

31. The method of claim 28, further comprising:
generating brand risk data describing the determined relation; and
providing the brand risk data to a particular operating environment, wherein the determination of risk is performed at least in part at the particular operating environment.

32. The method of claim 31, wherein the brand impact information includes unstructured data and the brand risk data is structured data.

33. The method of claim 28, wherein the brand impact information relates to a plurality of potential threats to one or more brands and relations are determined between each of the plurality of threats and at least one respective characteristic of operating environments.

34. The method of claim 28, further comprising collecting data from at least one particular operating environment and identifying the operating environment characteristic from the data collected from the at least one particular operating environment.

35. The method of claim 28, further comprising determining a severity of the risk associated with the particular brand.

36. At least one machine accessible storage medium having instructions stored thereon, the instructions when executed on a machine, cause the machine to:
identify brand threat information relating to potential threats to one or more brands;
identify a characteristic of one or more operating environments; and
determine a relation between a particular one of the potential threats and the characteristic;
wherein the relation is used in a determination of risk associated with a particular brand of an organization.

37. The storage medium of claim 36, wherein the brand impact information relates to a potential negative public relations impact.

38. The storage medium of claim 37, wherein the brand impact information describes an actual public relations impact on a second brand other than the particular brand.

39. The storage medium of claim 38, wherein determining the relation includes identifying a relationship between the particular brand and the second brand.

40. The storage medium of claim 39, wherein the particular brand is a brand of a particular organization and the second brand is at least one of a brand in a related industry and another brand of the organization.

41. The storage medium of claim 37, wherein the brand impact information includes at least one of website data, weblog data, news data, and brand research data.

42. The storage medium of claim 41, wherein the brand impact information identifies a brand threat associated with a particular exploit of operating environments and the identified characteristic includes a particular characteristic of a particular operating environment of the organization relating to the particular exploit.

43. The storage medium of claim 42, wherein the determination of risk includes determining whether the particular operating environment is vulnerable to the exploit based at least in part on the particular characteristic of the particular operating environment.

44. The storage medium of claim 36, wherein the operating environment characteristic relates to an operating environment of a particular organization and the relation between the operating environment characteristic and the particular potential threat is based at least in part on a type of business of the particular organization.

45. The storage medium of claim 36, wherein the relation between the operating environment characteristic and the particular potential threat is based at least in part on a type of asset included in the operating environment.

46. The storage medium of claim 36, wherein the relation between the operating environment characteristic and the particular potential threat is based at least in part on a type of data handled using the operating environment.

47. The storage medium of claim 36, wherein the characteristic includes a known vulnerability included in at least some operating environments and the determined relation identifies that the known vulnerability potentially increases risks to one or more brands.

48. The storage medium of claim 36, wherein the brand impact information is collected from a plurality of sources.

49. A system comprising:
at least one processor device;
at least one memory element; and
a brand risk module, adapted when executed by the at least one processor device to:
identify brand threat information relating to potential threats to one or more brands;
identify a characteristic of one or more operating environments; and
determine a relation between a particular one of the potential threats and the characteristic;
wherein the determined relation is used in a determination of risk associated with a particular brand of an organization.

50. The system of claim 49, further comprising a risk assessment system adapted to determine the risk associated with the particular brand of the organization.

51. The system of claim 50, wherein the risk assessment system determines the risk based at least in part on system data collected from a particular operating environment associated with the organization.

52. The system of claim 49, wherein the brand risk module maintains brand risk data describing determined relations between respective operating environment characteristics and associated potential threats to one or more brands.

53. The system of claim 52, wherein determining the risk includes:
identifying particular brand risk data pertaining to at least one condition of a particular operating environment of the organization.
